(19) United States
(12) Patent Application Publication
(10) Pub. No.: US 2016/0051087 A1
(43) Pub. Date: Feb. 25, 2016

(54) GRILLING OVEN

(71) Applicant: Quang Ngoc NGUYEN, thanh pho Thu Dau Mot (VN)

(72) Inventor: Quang Ngoc NGUYEN, thanh pho Thu Dau Mot (VN)

(21) Appl. No.: 14/780,377

(22) PCT Filed: Mar. 24, 2014
(86) PCT No.: PCT/VN2014/000001

§ 371 Date: Sep. 25, 2015

(30) Foreign Application Priority Data
Mar. 26, 2013 (VN) 1-2013-00942

(51) Int. Cl. A47J 37/07

(52) U.S. Cl. CPC A47J 37/07

(57) ABSTRACT

A grilling oven for foodstuffs comprising an oven casing having rows of apertures/gaps in the lower section uniformly facing various directions. The grilling oven has three layers disposed apart from each other by the supporting bars attached to the plates/grids in the bottom-to-the-top order. The plates/grids include the plate/grid containing the burning materials, the plate/grid is used to scatter and increase the heat and prevent the fat and nutritious juices from overflowing to the burning materials, the plate/grid containing the foodstuff to be grilled. These plates/grids and supporting bars are removable from the oven casing since the diameters of the plates/grids are smaller than the internal diameter of the oven wall. The oven cover has various rows of ventilation holes disposed uniformly throughout the cover to adjust and guide—distribute the heat in contact with the foodstuff more uniformly so that the foodstuff will not be burnt out.

### CROSS-REFERENCE TO RELATED APPLICATIONS

This application is a National Stage application of International Application No. PCT/VN2014/000001 filed on Mar. 24, 2014, which claims priority of Vietnamese application Serial Number 1-2013-00942, filed on Mar. 26, 2013, both of which are incorporated herein by reference in their entireties.

### BACKGROUND OF THE INVENTION

1. Technical Field

The present invention relates to grilling oven for foodstuffs.

2. Background of the Invention

Currently in the market, when using most of the types of electric, gas, charcoal or lumber grilling oven . . . the flame generally comes into direct contact with foodstuff to be grilled, easily resulting in burning the same since the flame has been nonuniformly dispensed, and therefore the hygiene of the foodstuff could not be guaranteed.

It becomes more dangerous when grilling the foodstuff which has been marinated with oil, fat or inherently containing certain oil and/or fat amount like meat, fish or those containing nutritious juice such as vegetables, tubers, fruits, etc. When being grilled at high temperature fat and nutritious juices have melted, being partially burnt to generate a uncontrolled flame which has resulted in increasing the temperature that might burn out the foodstuff and emit toxic gas and substances that might in turn cause cancer or being harmful to human health and pollute the surrounding environment. A part of fat and nutritious juices may flow downward to reduce the temperature of the grilling compartment, to extinguish burning materials leading into wasting energy, inconvenience and time-consuming of the users when grilling foodstuff.

The cover of the grilling oven generally are disposed the ventilation holes on the top thereof (centrally) therefore when grilling, the heat tends to accumulate at the centre of the grilling oven and the temperature thereat is higher than that at the surrounding regions thereby the foodstuff in these regions tends to be burned out before being grilled thoroughly. This results in decreasing the quality of the food, difficulty in grilling and time-consuming as well as generating toxicants which causes cancer and affects the health of the users.

And based on the technical solution entitled “Grilling oven for foodstuff without using the electricity” as specified in the Vietnamese utility solution application No. 2-2007-00113 for a patent for utility solution filed Jul. 31, 2007.

### SUMMARY OF THE INVENTION

The objective of the present invention is to provide an grilling oven for foodstuffs which overcome the above mentioned disadvantages.

To achieve this objective, the grilling oven for foodstuffs according to the present invention comprises: an oven casing containing rows of apertures/gaps uniformly facing various directions, wherein there is an oven door disposed close to the central section of the oven casing which serves to exchange frame/shelve containing burning materials, wherein the layers are disposed in the oven casing spaced from each other by supporting bars attached to plates/grids in the bottom-to-the-top order which include the burning material containing plate/grid, the heat scattering and increasing plate/grid that can prevent the oil, fat and/or nutritious juices from overflowing to the burning materials and the plate/grid containing the food to be grilled; wherein the plates/grids and supporting bars composed of metal materials which have the excellent heat conductivity therefore the heat shall be scattered fairly uniformly throughout the grilling compartment. These plates/grids and supporting bars can be removed from the oven casing since the diameters of the plates/grids is smaller than the internal diameter of the oven wall; an oven cover containing various rows of ventilation holes uniformly disposed over the whole surface of the cover and a blocking panel system to open/close the ventilation holes in order to guide the heat conducting to adjust the temperature in the grilling compartment for foodstuff and more uniformly guide-distribute the heat in contact with the foodstuff to avoid the food's burning out; the oven door disposed close to the central section of the oven casing serves to exchange the frame/shelve containing the burning materials.

### BRIEF DESCRIPTION OF DRAWINGS

FIG. 1 is a detailed view of the inventive grilling oven in the to be assembled state.

FIG. 2 is a detailed view of the inventive grilling oven in the assembled state.

### DETAILED DESCRIPTION OF THE INVENTION

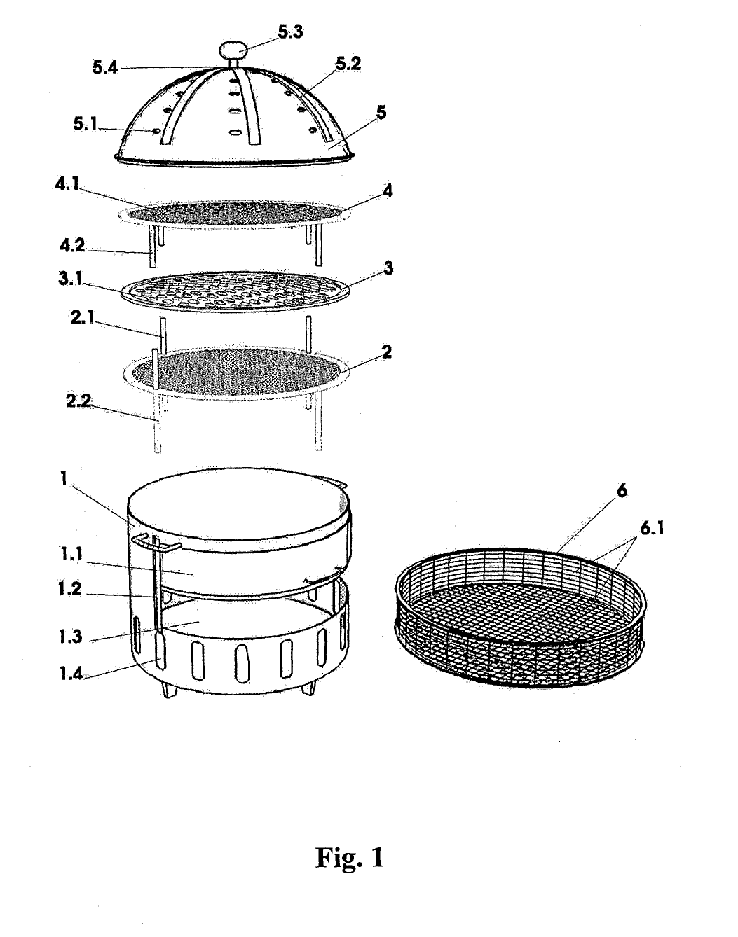

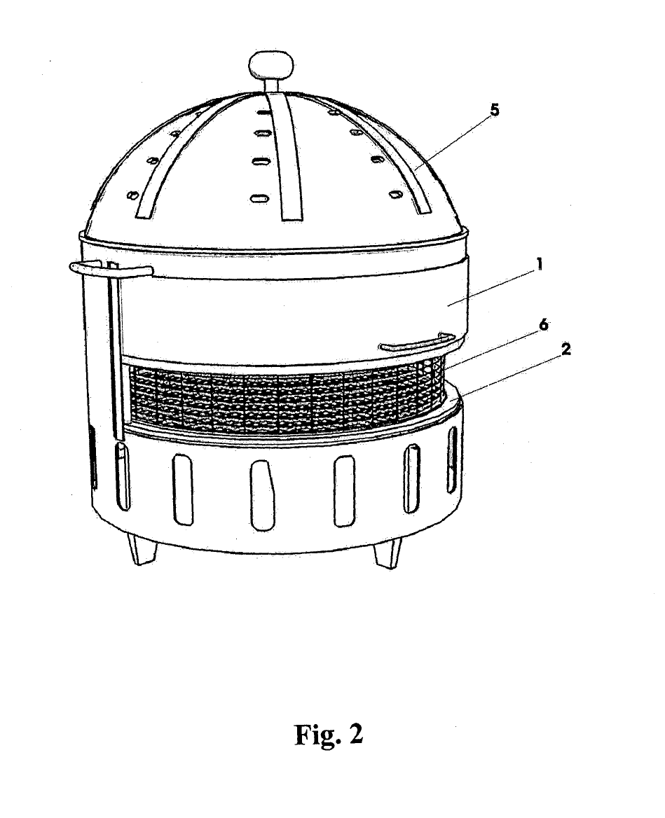

According to FIG. 1 and FIG. 2, the grilling oven for foodstuffs of the present invention comprises the oven casing 1 having oven door 1.1, oven door 1.3, sliding rail/coulisse 1.2 to close/open the oven door, air supplying gaps 1.4; there are supporting bars disposed inside the oven attached to plate/grid 2 in the bottom-to-the-top order being the plates/grids connected to the upper supporting bars 2.1 and the lower supporting bars 2.2 to have the burning material placed thereon; plate/grid 3 composed of metal panel having gaps/apertures uniformly disposed in order to scatter—increase the heat, at the edges of the gaps/apertures are disposed truncated conical rims 3.1 higher than the metal panel surface in order to prevent the oil, fat and nutritious from overflowing into contact with the burning materials and grilling compartment; plate/grid 4 also composed of metal grid 4.1 and supporting bars 4.2 for foodstuff to be grilled; these plates/grids can be easily removed from oven casing 1 because the diameters of these plates/grids are smaller than internal diameter of the oven wall; an oven cover 5 having various rows of ventilation holes 5.1 disposed uniformly throughout the cover and having a blocking panel system 5.2 (inside and outside of the cover) to close/open the ventilation holes largely/little in order to guide the heat conducting and adjust the temperature in the grilling compartment for foodstuff and guide—distribute the heat into contact with foodstuff more uniformly so that to prevent the foodstuff from burning out, wherein the oven door 1.3 disposed in the central section of the casing serves to close/open for exchanging the frame/shelve containing the burning materials 6 composed of grid 6.1.

The plate/grid 2 having the upper and lower supporting bars was placed in the oven casing 1, the frame/shelve 6 containing the ignited burning materials was placed above the plate/grid 2. The door of the oven was closed. The plate/grid 3 made from metal panel having gaps/apertures were placed above the supporting bars. Further, the plate/grid 4 having the supporting bars was placed above the plate/grid 3 vertically spaced therefrom a height equal to the height of the supporting bars and the foodstuff to be grilled was placed on the plate/grid 4. The oven cover 5 was closed and the blocking panel 5.2 of oven cover 5 was opened the ventilation holes 5.1 largely/little depending on the foodstuff. When grilling foodstuff, the flame passed through the gaps/apertures to convey the heat upwards. Since the holes were uniformly disposed throughout the oven cover, the heat had been guided and scattered uniformly in the grilling compartment into uniform contact with the foodstuff and exit uniformly so that the foodstuff was uniformly grilled and not burnt out; during the grilling, some oil, fat, juices from the foodstuff flowed into the plate/grid 3 as the edges of the gaps/apertures on the plate/grid 3 having the truncated conical rims and being higher than the plate/grid surface therefore the oil, fat, and juice drops could not drop directly through the gaps/apertures due to the pressure created by the flame and the heat against the gaps/apertures, therefore dropped onto the surface of the plate/grid 3. At the same time, the oil, fat and juices did not overflow over the truncated conical rims 3.1 on the plate/grid 3 and being higher than the surface of the plate/grid; they automatically flowed to reach the internal oven wall and then to the bottom layer of oven. Therefore the oil, fat and juices could not be burnt out during the grilling of the foodstuff, thereby the grilled foodstuff became safer.

What has been described above are preferred aspects of the present invention. It is of course not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, combinations, modifications, and variations that fall within the spirit and scope of the appended claims.

I claim:

1. A grilling oven for foodstuffs comprising:
an oven casing having air supplying gaps facing various directions uniformly, in interior oven casing having three projections disposed apart from each other to form the annular holding members for holding the plates/grids in the bottom-to-the-top order being the burning material containing plate/grid made of metal panel having the gaps/apertures of any shape punched therein for containing the burning materials thereon in order to generate flame, the heat scattering and increasing plate/grid made of metal grid to scatter and increase the heat, the plate/grid containing the foodstuff to be grilled also made of metal panel, these plates/grids are removable from the oven casing since the diameter of the lower plates/grids is smaller than the internal diameter of the annular holding members of the upper projections,
an oven cover having a close/open means to close/open the ventilation holes in order to adjust the air so that it is possible to change the temperature in the grilling oven and make the heat scattered uniformly in the grilling compartment;
wherein the grilling oven further comprises:
supporting bars attached to the plates/grids, respectively, having flexible removability in relation to the oven casing, plate/grid for preventing the oil, fat and nutrients from flowing into contact with the burning materials and grilling compartment, wherein the edges of the gaps/apertures of the plate/grid form the surrounding truncated conical rims which are higher than the surface of the metal panel.

2. The grilling oven according to claim 1, wherein the oven casing has an oven door, a sliding rail/coulisse and a door cover which serve to be closed/opened for exchanging the frame/shelve containing the burning materials composed of grid, an oven casing cover having rows of ventilation holes disposed uniformly throughout the cover and having a two-layer blocking panel system (inside and outside of the cover) which serve to close/open the ventilation holes largely or little in order to guide the heat conducting and adjust the temperature in the grilling compartment for foodstuff and scatter the heat into contact with the foodstuff more uniformly so that the foodstuff will not be burnt out.
